(19) United States
(12) Patent Application Publication
(10) Pub. No.: US 2009/0006433 A1
(43) Pub. Date: Jan. 1, 2009

(54) Extensible category and property grouping for object editing

(75) Inventors: Alan J. Gasperini, Redmond, WA (US); Gary Linscott, Kirkland, WA (US); Amir M. Khella, Redmond, WA (US); Unnikrishnan Ravindranathan, Issaquah, WA (US); Mark Boulter, Monroe, WA (US); James K. Nakashima, Kirkland, WA (US); Juraj Hlavac, Seattle, WA (US); Brian K. Pepin, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/824,409

(22) Filed: Jun. 29, 2007

(51) Int. Cl. G06F 17/30

(52) U.S. Cl. 707/100; 707/E17.001

(57) ABSTRACT

Various techniques for assembling object properties are disclosed. For example, one such method includes receiving an object identification that indicates an object, and receiving a property associated with the object. Property category identification is performed that identifies a property category associated with the aforementioned property, and the property is dynamically associated with the identified property category. In some instances, such methods further include providing a category editor that allows for modifying a plurality of properties associated with the property category.

### BACKGROUND

Various electronic document production systems have been developed that allow for adding one or more objects, such as fonts, tables, and drawings, to a document. Such systems typically provide methods for modifying various properties associated with a given object (herein known as “object editing”). This process of object editing is generic to a number of products and is applicable to any program where it is possible to set the properties of an object. As an example, a word processor application allows a user to change the font properties of the text in a document. In such an application, the set of potentially editable objects is often static, and is known at the time the system is built. While the static nature is effective for the aforementioned products, it is overly limiting to the purposes of other products. Thus, other systems have been developed that offer an ability to modify properties for a dynamic set of objects. However, such dynamic property modification may lead to an unwieldy user interface and the inefficiencies associated therewith.

### SUMMARY

Described herein are, among other things, techniques for adding property editors for objects (herein called “object editors”) for objects dynamically added to software applications. For example, in a word processing application, text fonts may be objects shipped with and built-in to (herein called “original properties”) the application. If the word processing application allowed dynamically adding objects, a user may, for example, be able to add a rectangle object, which would allow the user to place a rectangle into a document created by the word processing application. Because the rectangle object was dynamically added; it was not originally included with the word processing application; it may be necessary to provide a way to edit the width, height, location, fill color, line width, line colors, or any other properties exposed, or available to edit, by the rectangle.

In accordance with one implementation presented herein this functionality is provided by allowing the creation of categories of properties, and using these categories to provide suitable object editors for properties of the added object. In this example, there may be a “layout” category that would be associated with the size and location properties, while there may be a color category associated with the fill color and line color properties. An object editor could then be created based on the properties and the categories with which they are associated. A layout category associated with the width property may result in an object editor displaying a width of the rectangle in a text box control, allowing a user to view or edit the width by typing a value, for example. The fill color and line color, as another example, may be viewed and edited with a control based on a color wheel control. Each of the properties exposed by the rectangle that have categories associated may use an appropriate control for an associated category.

Because some categories of properties may not be included when the original application was created, a category editor may be used to associate appropriate controls to categories of properties. A category editor, for example, may allow the creation of a category of circular objects. A category of circular objects may be associated with properties for defining a circle, such as the center, diameter, fill color, line color, x coordinate of the center, y coordinate of the center, and the like. The category editor would allow associating an appropriate control to each of the exposed properties, for example a text box for diameter, color wheel for fill color, and so on. If an object is then created that includes a circle and another object, such as a rectangle as described above, an object editor may be provided which uses information from both the circle category and the rectangle category to allow editing of any exposed properties.

### DESCRIPTION OF THE DRAWINGS

A further understanding of the various embodiments of the present invention may be realized by reference to the figures, which are described in remaining portions of the specification. In the figures, like reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a flow diagram showing an example method for dynamically grouping object properties;

FIGS. 2a-2c provide a graphical example of the processes set forth in relation to FIG. 1;

FIG. 3 is a flow diagram showing an example method for assembling a unified object editor;

FIGS. 4a-4d provide a graphical example of the processes set forth in relation to FIG. 3; and

FIG. 5 depicts an example of a system in accordance with various embodiments of the present invention.

### DETAILED DESCRIPTION

Various embodiments of the present invention provide techniques to logically group editable or otherwise accessible object properties in an extensible manner. In some cases, embodiments may further provide an ability to customize editors that display one or more properties that have been logically grouped. Such grouping may be associated with a user interface that, among other things, aids a user in efficient development. Such user interfaces may be presented as category editors that include one or more properties within a logically defined category. In some cases, such user interfaces may include a number of category editors assembled into a unified object editor. Such a unified object editor allows a user to accesses a number of object properties spanning different categories via a common user interface.

Some embodiments of the present invention provide methods for assembling object properties. Such methods include receiving an object identification that indicates an object, and receiving a property associated with the object. As used herein, the term “object” is used in its broadest sense to mean any element associated with an electronic document, electronic presentation, electronic design, or the like. Thus, as just some of many examples, an object may be a group of text included in an electronic document, a graphical image included in an electronic design, a layout element included in an electronic print layout. Based on the disclosure provided herein, one of ordinary skill in the art will recognize a variety of objects that may be manipulated using the various embodiments of the present invention. As used herein, the term “property” is used in its broadest sense to mean a characteristic of an object. Thus, as just one example, a property may indicate visible features such as the size and color of an object. As another example, a property may indicate a non-visible feature such as an argument that may be associated with an object, or an interaction between the object defined by the property and other objects. Based on the disclosure provided herein, one of ordinary skill in the art will appreciate that there are many properties and property types that may be used in relation to embodiments of the present invention.

In the aforementioned methods, a property category identification is performed that identifies a property category associated with the aforementioned property, and the property is dynamically associated with the identified property category. As used herein, a “property category” is interpreted in its broadest sense to mean any grouping of one or more properties that applies to a number of objects without being specific to one single object. Thus, a property category may be, but is not limited to, a category of properties related to the layout of objects or a category of properties related to the color or fill features of objects. Based on the disclosure provided herein, one of ordinary skill in the art will appreciate a variety of property categories that may be defined that allow for grouping one or more properties used in relation to defining objects. As used herein, the term “dynamically” is used in its broadest sense to mean modification of an otherwise static element or application. Thus, as just one of many examples, dynamically associating a property with a property category may include incorporating a new property in a preexisting property category. A preexisting property category may include one or more original properties, and may be augmented by newly defined properties. The phrase “original property” is broadly interpreted to mean any property that was incorporated in a product at the release thereof. The phrase “non-original” property is generally interpreted to mean any property that was incorporated into a product through a customization of the particular product or element. In some instances of the aforementioned embodiments, the methods further include providing a category editor that allows for modifying a plurality of properties associated with the property category. As used herein, the phrase “category editor” is used in its broadest sense to mean any tool that allows editing and/or viewing of information known to the particular editor. Various instances of the aforementioned embodiments further include combining two or more category editors into a unified object editor. As used herein, the phrase “unified object editor” is used in its broadest sense to mean any tool that allows editing and/or viewing of information about a particular object that is known to two or more category editors.

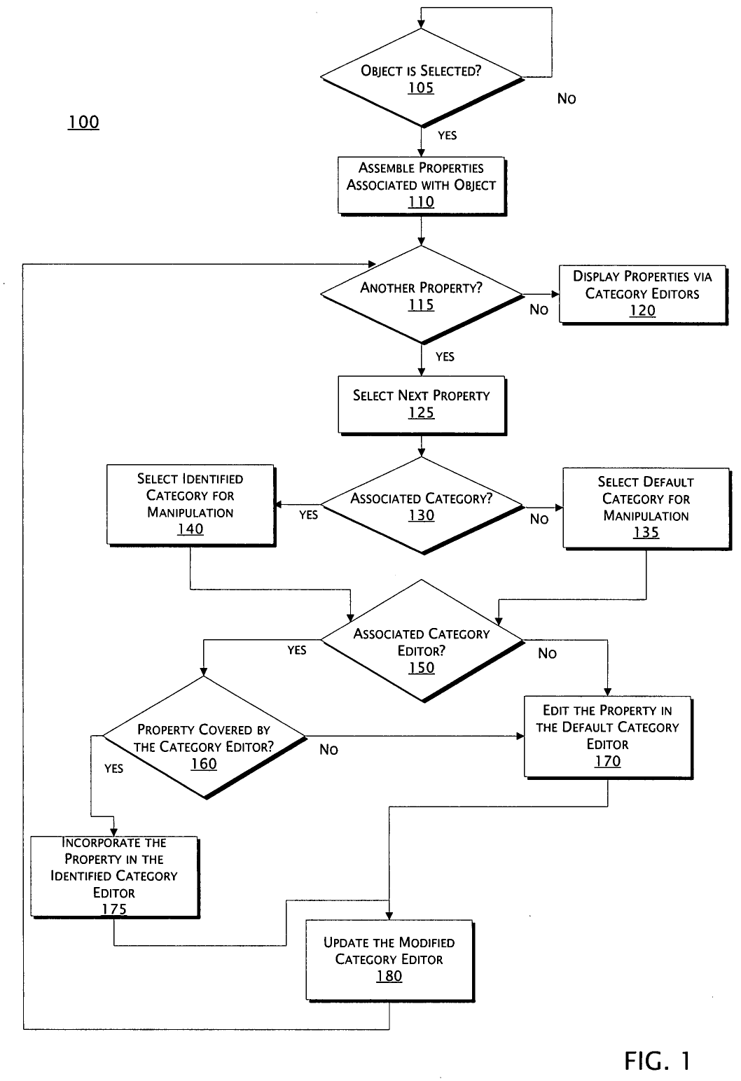

Turning to FIG. 1, a flow diagram 100 shows a method in accordance with some embodiments of the present invention for dynamically grouping object properties. Following flow diagram 100, an object is selected (block 105). This may include, for example, selecting an object associated with an electronic document using a mouse or other input device associated with a computer. The identity of the object is received and various properties associated with the object are enumerated (block 110). In turn, each of the enumerated properties is assembled into category editors.

It is determined whether one or more properties remain to be categorized (block 115). Where another property remains to be categorized (block 115), the next property is selected (block 125). It is then determined whether the selected property is associated with a particular category (block 130). In some cases, this may include identifying a category that incorporates a genre of properties to which the selected property relates. Alternatively, in some cases when a property is implemented in relation to an object, the category to which the property belongs is manually associated to the property. Where a particular category is identified for the property, the identified category is selected (block 140). Alternatively, where either a particular category cannot be determined or has not been assigned, a default category is selected for the property (block 135). As used herein, a “default category” is any category that is designated to associate with one or more properties that are not otherwise identified or associated with another category.

In addition, it is determined whether a category editor exists for the identified category (block 150). Such a category editor is a tool that provides access to properties associated with the category. In some cases, access to the category editor may include an ability to both modify and view all properties in a category. In other cases, access to the category editor may include an ability to modify some subset of the properties, and only to view another subset of the properties. In yet other cases, access to the properties may only allow for viewing the properties within the category. Where a category editor does not exist for the particular category (block 150), an ability to edit the associated properties is made available through a default editor (block 170). Alternatively, where a category editor does exist (block 150), it is determined if the current property is covered by the category editor (block 160). Where a property is covered by a particular category editor, the category editor is the exclusive tool used to modify the property. In some embodiments of the present invention, more than one tool may be used to modify a given property. In such cases, block 160 is not utilized as the process of identifying associated categories and category editors may yield multiple category editors that are each modified to allow access to the particular property. Where the current property is not covered by the category editor (block 160), access to the current property is made available through the default editor (block 170). Alternatively, where the current property is covered by the category editor (block 160), the current property is incorporated in the identified category editor (block 175). The category editor or default editor that received the current property is then updated such that the current property becomes accessible via the updated editor (block 180).

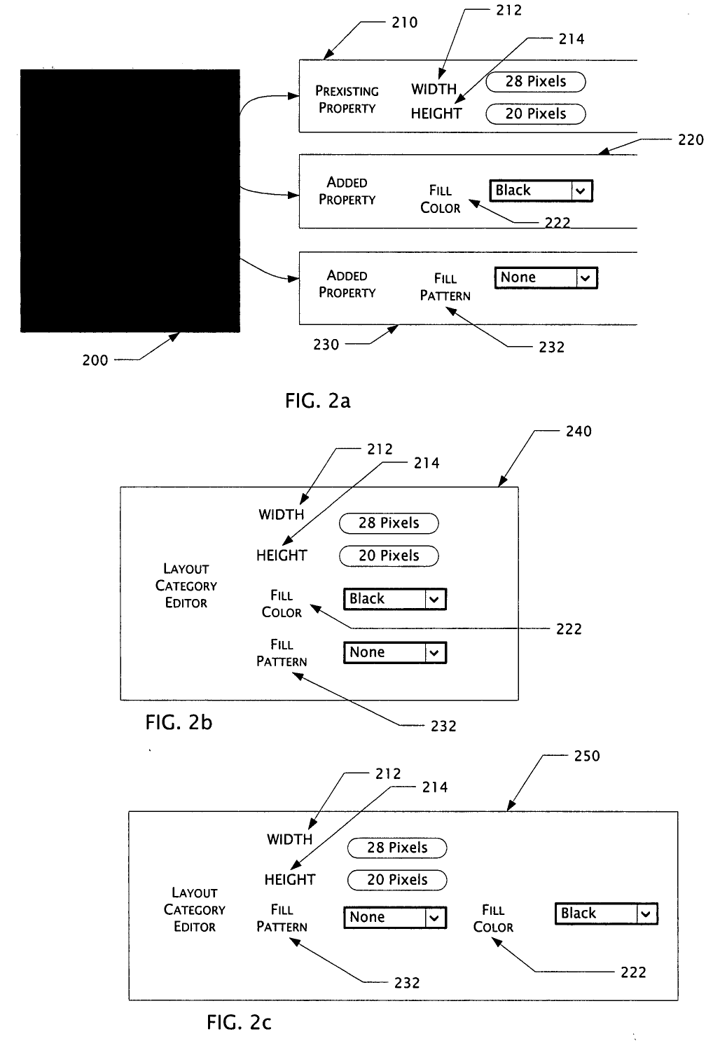

FIGS. 2a-2c provide a graphical example of the processes of flow diagram 100. It should be noted that the discussion of FIGS. 2a-2c is merely exemplary of one possible application of the systems and methods of the present invention. Based on the disclosure provided herein, one of ordinary skill in the art will recognize a variety of objects and properties that may be dealt with using embodiments of the present invention consistent with flow diagram 100. Further, one of ordinary skill in the art will recognize a variety of category editors that may be implemented to allow access to the included properties.

Turning to FIG. 2a, an object 200 is shown that includes a property set 210, a property set 220 and a property set 230. In this case, all of the property sets are associated with the same category, which in this case is an object layout category. Property set 210 includes a preexisting width property 212 and a preexisting height property 214. Width property 212 is the width of object 200, expressed as a number of pixels. The number of pixels may be edited, which causes a corresponding change in the width of object 200. Similarly, height property 214 is the height of object 200, which is expressed as a number of pixels. The number of pixels may be edited, which causes a corresponding change in the height of object 200. As an example, properties 212, 214 may be original properties that were incorporated in an original layout category editor. In contrast, property set 220 includes a customized or added fill color property 222, and property set 230 includes a customized or added fill pattern property 232. Fill color property 222 may be viewed and edited via a pull down selector that is implemented when the property is added. Similarly, fill pattern 232 may be viewed and edited via a pull down selector that is implemented when the property is added.

In operation, object 200 is selected and properties 212, 214, 222, 232 are enumerated. The first of the enumerated properties (i.e., width property 212) is selected and it is determined whether the property is associated with a category editor. In this case, width property 212 is associated with, for example, a layout category editor. In turn, it is determined whether the associated layout category editor covers width property 212. In this case, width property 212 is covered by the layout category editor, thus, width property 212 is incorporated in the layout category editor that is updated to allow access to width property 212. In some cases, width property 212 may have already been incorporated in layout category editor as it is an original property. In turn, the same process is repeated for each of height property 214, fill color property 222 and fill pattern property 232. Ultimately, each of the aforementioned properties is identified as being associated with the layout category editor and the layout category editor is updated to allow access to each of the four properties.

Turning to FIG. 2b, an exemplary layout category editor 240 is shown after incorporation of each of width property 212, height property 214, fill color property 222 and fill pattern property 232. As shown, layout category editor 240 expresses each of the properties in a stacked pattern with width property 212 atop height property 214, height property 214 atop fill color property 222, and fill color property 222 atop fill pattern property 232. In some embodiments of the present invention, this stacked pattern is the default layout for a category editor with the first property on the stack corresponding to original properties or the first property that is enumerated in relation to an object. The last property on the stack is the last property that is enumerated in relation to an object.

Other customized expressions of a category editor are possible in accordance with various embodiments of the present invention. FIG. 2c shows an example of a customized layout category editor 250. As shown, layout category editor 250 includes width property 212 stacked atop height property 214 similar to that shown in layout category editor 240. However, fill pattern property 232 is set next to fill color property 222, and both are set beneath height property 214. Such a customized expression of a category editor may be defined at the time that one or more properties are being added to a given object, or at a time that object properties are being assembled into category editors. Based on the disclosure provided herein, one of ordinary skill in the art will recognize a myriad of properties that may be incorporated into a given category editor, and a number of different expressions of those properties relative to one another in the category editor.

In some embodiments of the present invention, a user may create a category editor using default appearance characteristics without providing any input. In contrast, a user may select an application that allows creating a custom category editor. By creating such a custom category editor, a user is able to specify a layout for the rows of properties within the category editor. In one particular embodiment, the properties originally associated with an object all derive from a common base class. This base class may be used to provide much of the functionally required by controls that will be displayed in a visual layout, and does so by exposing a large set of properties. As an example, in one particular embodiment of the present invention, the following properties are all used to control the positioning of objects and/or elements thereof on a display: Width, Height, FlowDirection, HorizontalAlignment, VerticalAlignment, Margin, MinWidth, MinHeight, MaxWidth, MaxHeight, RenderTransform, RenderTransformOrigin, and LayoutTransform. There may also be additional properties that are context sensitive depending on how the element or object is used in the particular application. Further, in some cases, various properties operate on related properties. Such properties may be maintained in a tree such that the related or “children” properties are easily ascertained when a parent property is manipulated. In any event, a category editor may be defined that allows for modification of a variety of properties associated with a given object, and that maintains the relevant parent/child relationship between some of the properties. In some cases, parent/child properties may be presented in different category editors. In such cases, it may be desirable to present a user with both category editors whenever one is selected.

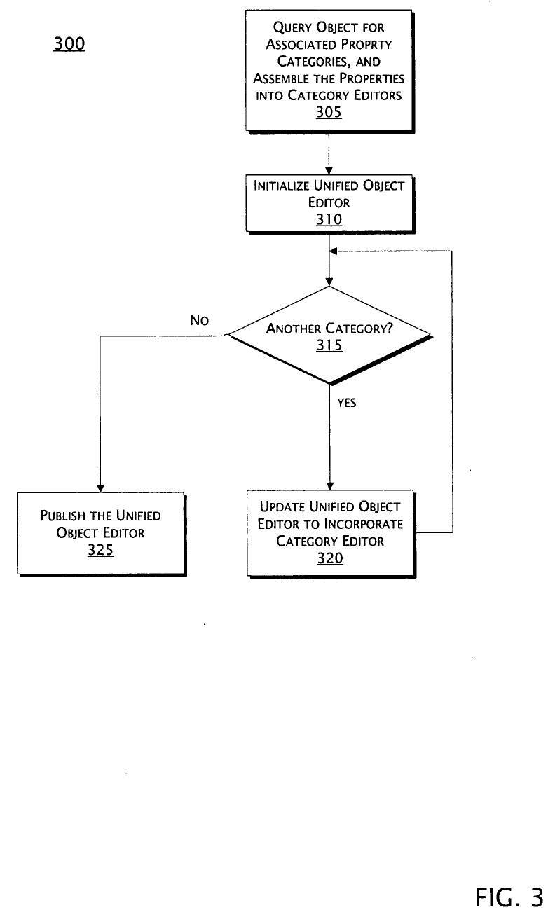

Turning to FIG. 3, a flow diagram 300 depicts a method in accordance with one or more embodiments of the present invention for assembling a unified object editor. Following flow diagram 300, a selected object is queried for properties associated therewith (block 305). This may include, for example, selecting an object using a mouse or keyboard command. This query results in the assembly of the various properties into category editors using, for example, a process such as that discussed above in relation to FIG. 1. In addition, a unified object editor is initialized 310 to accept one or more category editors and/or one or more individual property editors. For the purpose of this document, an individual property editor is an editor that allows for access to only a single property and may be considered a single property category editor.

Next, each category editor is incorporated in the unified object editor one at a time (block 320). This process of incorporating category editors into the unified object editor is repeated until each of the category editors has been incorporated (block 315). Once all of the category editors is incorporated into the unified object editor (block 315), the unified object editor is formatted and published to the user (block 325).

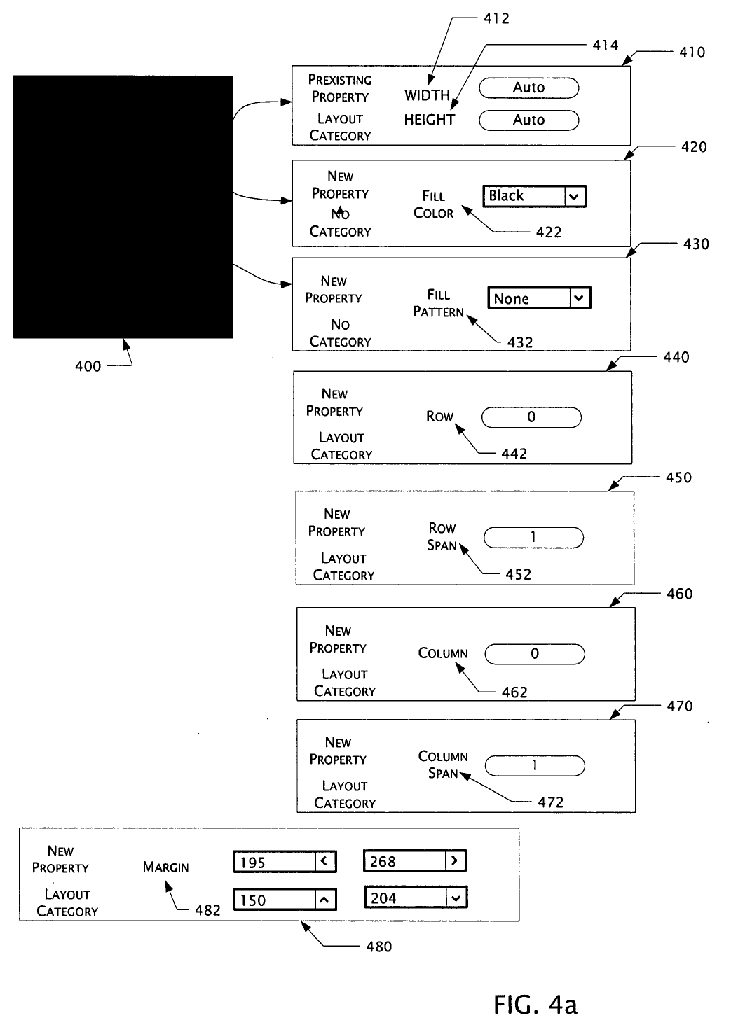

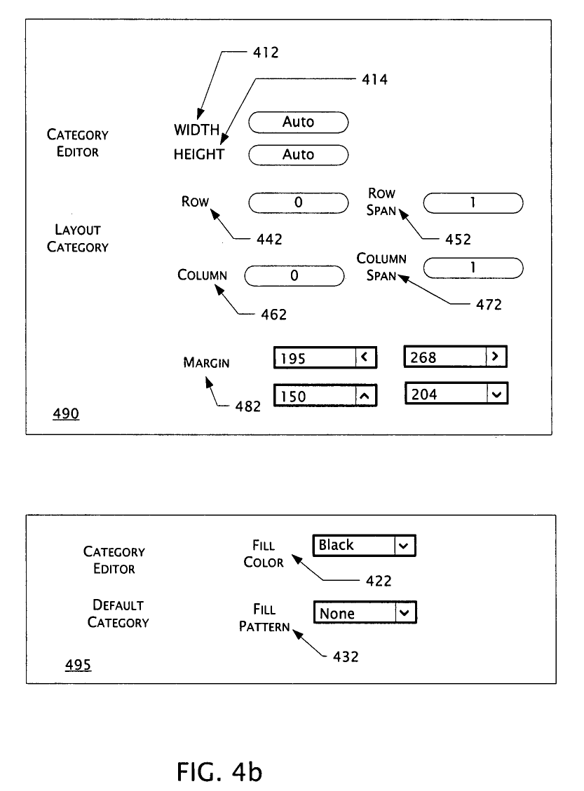

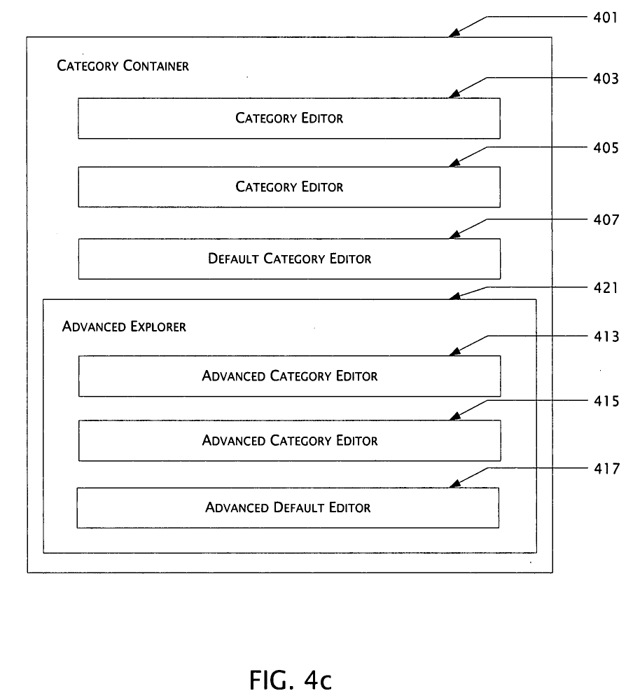

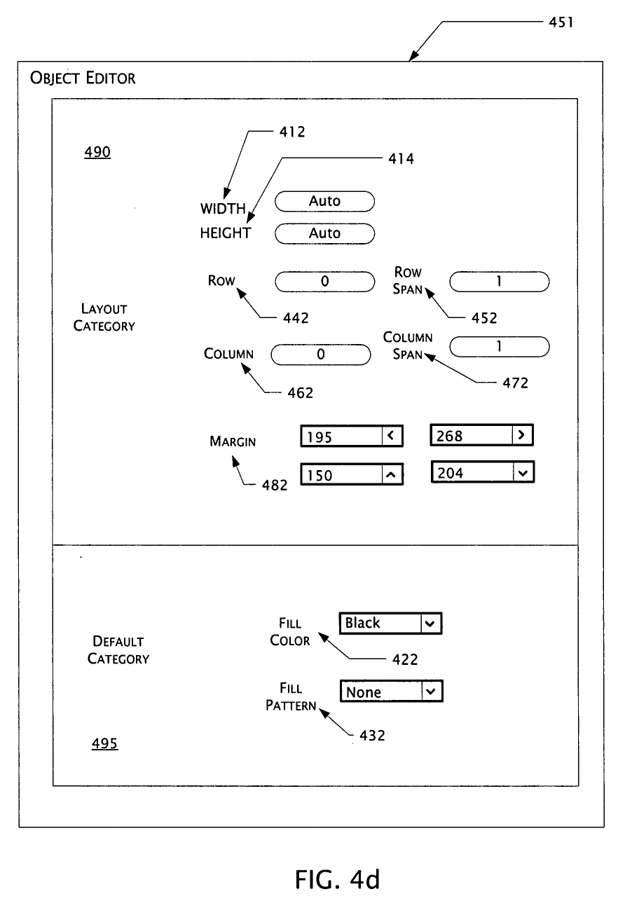

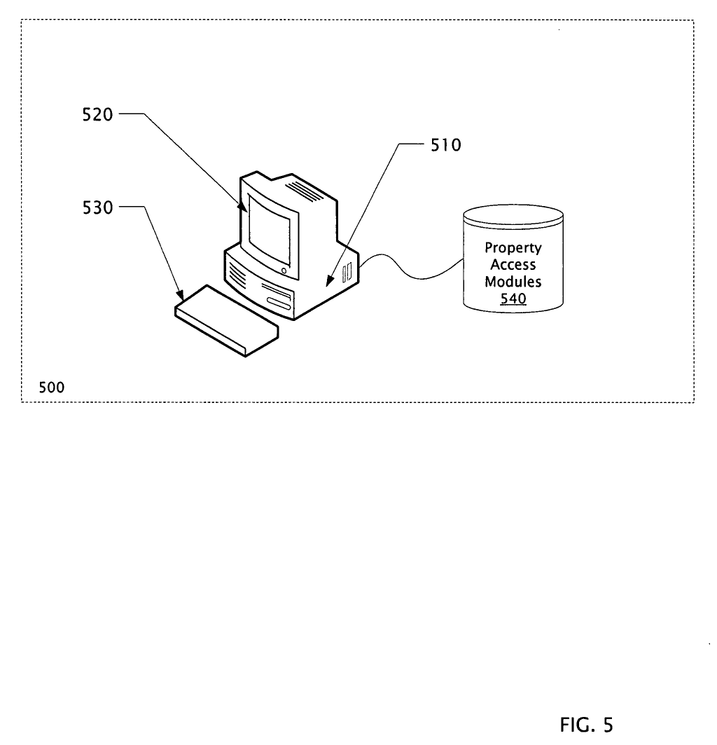

FIGS. 4a-4d provide a graphical example of the processes of flow diagram 300. It should be noted that the discussion of FIGS. 4a-4d is merely exemplary of one possible application of the systems and methods of the present invention. Based on the disclosure provided herein, one of ordinary skill in the art will recognize a variety of objects, properties and categories that may be dealt with using embodiments of the present invention consistent with flow diagram 300. Further, one of ordinary skill in the art will recognize a variety of unified object editors that may be implemented to allow access to the included categories.

Turning to FIG. 4a, an object 400 is shown that includes a property set 410, a property set 420, a property set 430, a property set 440, a property set 450, a property set 460, a property set 470 and a property set 480. In this case, property set 420 and property set 430 are not associated with any category, and the remaining property sets are associated with a layout category. Property set 410 includes a preexisting width property 412 and a preexisting height property 414. Width property 412 allows for viewing the width of object 400, which is expressed as a number of pixels. The number of pixels may be edited, which causes a corresponding change in the width of object 400. Similarly, height property 414 allows for viewing the height of object 400, which is expressed as a number of pixels. The number of pixels may be edited, which causes a corresponding change in the height of object 400. As an example, properties 412, 414 may be original properties that were incorporated in an original layout category editor.

In contrast, the other property sets include customized or added properties. In particular, property set 420 includes a customized or added fill color property 422 and property set 430 includes a customized or added fill pattern property 432. Property set 440 includes a customized or added row property 442; property set 450 includes a customized or added row span property 452; property set 460 includes a customized or added column property 462; property set 470 includes a customized or added column span property 472; and property set 480 includes a margin property 482. Each of the aforementioned properties may be editable and/or viewable via text boxes or pull down selector associated with the particular property.

In operation, object 400 is selected and properties 412, 414, 422, 432, 442, 452, 462, 472, 482 are enumerated. The first of the enumerated properties (i.e., width property 412) is selected and it is determined whether the property is associated with a category editor. In this case, width property 412 is associated with a layout category editor. In turn, it is determined whether the associated layout category editor covers width property 412. In this case, width property 412 is covered by the layout category editor, thus, width property 412 is incorporated in the layout category editor which is updated to allow access to width property 412. In some cases, width property 412 may have already been incorporated in layout category editor as it is an original property. The same process is then repeated for height property 414.

Fill color property 422 is then selected and it is determined whether a specific category editor is associated therewith. In this case, fill color property 422 is not associated with a specific category editor. Thus, fill color property 422 is incorporated into a default category editor that is designed to accept any non-associated properties. The same process is repeated for fill pattern property 432 that is also assigned to the default category editor.

The process is then repeated for row property 442 which is ultimately incorporated in the layout category editor. As each of the remaining properties (i.e., row span property 452, column property 462, column span property 472 and margin property 482) is also included in the layout category, the aforementioned process is repeated until each is incorporated into the layout category editor. While the present example utilizes only two categories (i.e., a layout category and a default category), one of ordinary skill in the art will recognize that embodiments of the present invention may be expanded to involve a number of properties respectively assigned to one of three or more categories.

Turning to FIG. 4b, an exemplary layout category editor 490 and default category editor 495 are shown. In particular, layout category editor provides access to width category 412, height category 414, row category 442, row span category 452, column category 462, column span category 472 and margin category 482. As shown, each of the aforementioned categories are arranged relative to one another in a non-stacked form suggesting that a customized layout category editor has been defined. Default category editor 495 receives the remaining unassigned properties (i.e., fill color property 422 and fill pattern property 432) in a default orientation. In this case, the default orientation provides for stacking one property atop another with the first property accessed being placed on top of the stack and the last property accessed being placed at the bottom of the stack. It should be noted that using such a stacked orientation is merely exemplary and that one of ordinary skill in the art will recognize a variety of default orientations that may be used in accordance with different embodiments of the present invention.

The different category editors may be assembled into a unified object editor. Assembling the category editors into the unified object editor may be done in accordance with a predefined category container 401 as depicted in FIG. 4c. As shown, category container 401 is designed to accept a number of category editors 403, 405 each staked atop another with a default category editor 407 being placed at the bottom of the stack of category editors. In addition, category container 401 includes an advanced expander 421 that includes advanced features that may be associated with each of category editors 403, 405 and default category editor 407. In particular, an advanced category editor 413 provides access to advanced features associated with category editor 403, an advanced category editor 415 provides access to advanced features associated with category editor 405, and an advanced default editor 417 provides access to advanced features associated with category editor 407.

Such advanced features may be accessed by, for example, selecting an “advanced” button (not shown) that may be integrated into a particular category editor. By selecting the advanced button, additional features that are accessible in relation to the particular category are made accessible to a user. Such advance features may be, but are not limited to, features or properties that are less often used by any given user. The advanced features may be removed by pressing a “close” button (not shown) that is incorporated into a particular advanced category editor. Based on the disclosure provided herein, one of ordinary skill in the art will recognize a variety of advanced properties and/or features that may be made available to a user in relation to one or more category editors. In addition, it may be that one or more of the category editors has an associated advanced category editor and that others do not. Further, it should be noted that while category container 401 shows two distinct category editors and a default category editors, that other category containers may incorporate more category editors or fewer category editors in accordance with different embodiments of the present invention. Further, it should be noted that while category container 401 indicates that the various category editors will be presented one atop the other, other category containers may provide for a different presentation depending upon the particular implementation.

FIG. 4d depicts a unified object editor 451 formed using the layout defined by category container 401 and comprehending the two category editors 490, 495 developed in relation to object 400. In particular, unified object editor 451 includes a stacked presentation with layout category editor 490 stacked on top of default category editor 495. As such, each of the properties identified in relation to object 400 are accessible via unified object editor 451. As just one of many advantages that may be achieved using one or more embodiments of the present invention, a user may be given access to most if not all properties associated with a given object through using a single unified object editor. As another advantage of one or more embodiments of the present invention, the ability to load and combine category editors renders a system extensible. It is possible for any control author to provide a category editor for the properties declared on that control, and if their control is reused and extended through class inheritance, the designed category editor may be reused by the new control and may be combined with any category editors that are declared by that new control. Based on the disclosure provided herein, one of ordinary skill in the art will recognize other advantages that may be achieved using one or more embodiments of the present invention.

FIG. 5 depicts a system 500 in accordance with various embodiments of the present invention. In particular, system 500 includes a computer 510 with various I/O devices including a display 520 and a keyboard 530. Computer 520 may be any computer known in the art including, but not limited to a microprocessor based personal computer available from various manufacturers. A computer readable medium 540 is accessible to computer 510 and includes one or more software applications. As shown, one of the software applications is a property access module that provides for grouping properties, instantiating category editors, and/or instantiating unified object editors in accordance with various embodiments of the present invention. Computer readable medium 540 may be comprised of one or more media that are accessible to computer 510. Thus, computer readable medium may be, but is not limited to, a hard disk drive, a CD ROM, a random access memory (RAM), another magnetic or optical storage media, combinations of the aforementioned, or the like. The applications maintained on computer readable medium 540 include a number of instructions executable by the computer that cause the computer to perform processes in accordance with the various embodiments of the present invention.

In conclusion, the present invention provides novel systems, methods and arrangements for providing access to object properties. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

1. A method for assembling object properties, the method comprising:
receiving an object identification which indicates an object;
receiving a property associated with the object;
performing a property category identification; and
dynamically associating the property with the property category.

2. The method of claim 1, wherein the method further comprises:
providing a category editor, wherein the category editor allows for modifying a plurality of properties associated with the property category.

3. The method of claim 1, wherein the property is a first property, wherein the object is further associated with a second property, wherein the second property is associated with the property category, wherein the second property is an original property to the property category, and wherein the method further comprises:
providing a category editor, wherein the category editor allows for modifying at least one original property; and
dynamically updating the category editor, wherein at least the first property and the second property are modifiable via the category editor.

4. The method of claim 3, wherein the first property and the second property are both of a property type, and wherein a plurality of properties of the property type are associated with the property category.

5. The method of claim 1, wherein the property is a first property, wherein the object is further associated with a second property, wherein the second property is associated with the property category, and wherein the method further comprises:
providing a category editor, wherein at least the second property is modifiable using the category editor; and
dynamically updating the category editor, wherein the first property is viewable via the category editor.

6. The method of claim 1, wherein the property category is a default category.

7. The method of claim 1, wherein the property is a first property, wherein the property category is a first property category, and wherein the method further comprises:
receiving a second property associated with the object, wherein the property category identification indicates a second property category associated with the second property; and
dynamically associating the second property with the second property category.

8. The method of claim 7, wherein the second property category is a default category.

9. The method of claim 7, wherein the method further comprises:
dynamically updating a first category editor, wherein the first property becomes modifiable via the first category editor; and
dynamically updating a second category editor, wherein the second property becomes modifiable via the second category editor.

10. The method of claim 7, wherein the method further comprises:
providing a first category editor, wherein the first category editor allows for modifying the first property;
providing a second category editor, wherein the second category editor allows for modifying the second property; and
combining the first category editor and the second category editor in a unified object editor, wherein the first property and the second property are modifiable via the unified object editor.

11. An object editing system, the system comprising:
a computer; and
a computer readable medium, wherein the computer readable medium includes instructions executable by the computer to:
identify a first property associated with an object;
identify a second property associated with the object;
perform a property category identification, wherein a first property category associated with the first property is identified, and wherein a second property category associated with the second property is identified; and
dynamically associating the first property with the first property category; and
dynamically associating the second property with the second property category.

12. The system of claim 11, wherein the first category and the second category are the same category, and wherein the computer readable medium further includes instructions executable by the computer to:
provide a category editor, wherein the category editor allows for modifying the first property and the second property.

13. The system of claim 11, wherein the computer readable medium further includes instructions executable by the computer to:
provide a first category editor, wherein the first category editor allows for modifying the first property; and
provide a second category editor, wherein the second category editor allows for modifying the second property.

14. The system of claim 13, wherein the first property is a non-original property, and wherein the second property is a non-original property.

15. The system of claim 13, wherein the instructions executable to provide the first category editor are executable to:
dynamically update the first category editor.

16. The system of claim 13, wherein the computer readable medium further includes instructions executable by the computer to:
combining the first category editor and the second category editor in a unified object editor, wherein the first property and the second property are modifiable via the unified object editor.

17. A computer readable medium having stored thereon instructions, which when executed by one or more microprocessor based devices cause a method comprising the following processes to execute:
receiving an object identification, wherein the object identification indicates an object;
receiving a property associated with the object;
performing a property category identification, wherein a property category associated with the property is identified;
dynamically associating the property with the property category; and
providing a category editor, wherein the category editor allows for modifying the property associated with the property category.

18. The computer readable medium of claim 17, wherein the property is a first property, wherein the object is further associated with a second property, wherein the second property is associated with the property category, wherein the second property is modifiable using the category editor, and wherein the computer readable medium further includes instructions executable by the microprocessor based device to:
dynamically update the category editor, wherein the first property become accessible via the category editor.

19. The computer readable medium of claim 17, wherein the property is a first property, wherein the property category is a first property category, and wherein the computer readable medium further includes instructions executable by the microprocessor based device to:
receive a second property associated with the object, wherein the property category identification indicates a second property category associated with the second property; and
dynamically associate the second property with the second property category.

20. The computer readable medium of claim 19, wherein the category editor is a first category editor, and wherein the computer readable medium further includes instructions executable by the microprocessor based device to:
provide a second category editor, wherein the second category editor allows for accessing the second property; and
combine the first category editor and the second category editor in a unified object editor, wherein the first property and the second property are accessible via the unified object editor.
